(19) United States
(12) Patent Application Publication
(10) Pub. No.: US 2026/0097715 A1
(43) Pub. Date: Apr. 9, 2026

(54) TRUCK CARGO RACK

(71) Applicant: Ruifang Xiang, Riverside, CA (US)

(72) Inventor: Ruifang Xiang, Riverside, CA (US)

(21) Appl. No.: 18/905,911

(22) Filed: Oct. 3, 2024

(51) Int. Cl. B60R 9/04

(52) U.S. Cl. CPC B60R 9/04; B60Y 2200/14

(57) ABSTRACT

A truck cargo rack includes a plurality of first supporting frames uprightly supported on a truck; a plurality of second supporting frames transversely coupled with the first supporting frame; a plurality of horizontal supporting frames coupled with the first supporting frames and the second supporting frames; at least one force distribution assembly coupled with the second supporting frame and configured to distribute a shaking force; and at least one locking assembly having a first locking unit and a second locking unit pivotally coupled with the first locking unit through a pivot mechanism to perform a high affixing position and a low affixing position; wherein the force distribution assembly comprises a base member and a main force distribution unit spacedly arranged with the base member and locked on the base member.

### FIELD OF THE DISCLOSURE

The present disclosure relates to a truck cargo rack, and more particularly to the truck cargo rack with at least one force distribution assembly that distributes an unstable force generated from the whole body of the truck cargo rack while the truck is in an operating situation.

### BACKGROUND OF THE DISCLOSURE

Generally, pickup trucks typically have an open bed surrounded by wall structures for containing and carrying cargo. Often, it is desirable to mount a cargo rack over the bed of the truck to secure specific items. One approach is to mount towers and crossbars to opposing side wall structures (bed rails) of the truck's bed.

Most cargo rack systems comprise a framework of four or more upright side rails, two of which are mounted atop or alongside one of the truck's side walls and the other two located on the opposite side wall. Cross bars are connected between aligning side rails on opposite side walls so that they span the truck's bed and support equipment, materials, or other loads in an elevated position above the truck bed.

However, since the cargo is loaded in an elevated position above the truck bed, the cargo rack may easily shake or vibrate while driving. In such a situation, the driver needs to frequently check that the bolts and nuts are tightened properly and in good condition. Once the cargo rack keeps shaking or vibrating, the cargo loaded thereon is easily able to fall from the rack.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily prevent them.

### BRIEF SUMMARY OF THE DISCLOSURE

In a general implementation, a truck cargo rack may comprise a plurality of first supporting frames uprightly supported on a truck; a plurality of second supporting frames transversely coupled with the first supporting frame; a plurality of horizontal supporting frames coupled with the first supporting frames and the second supporting frames; at least one force distribution assembly coupled with the second supporting frame and configured to distribute a shaking force; and at least one locking assembly having a first locking unit and a second locking unit pivotally coupled with the first locking unit through a pivot mechanism to perform a high affixing position and a low affixing position; wherein the force distribution assembly comprises a base member and a main force distribution unit spacedly arranged with the base member and locked on the base member.

In another aspect combinable with the general implementation, the first supporting frames comprise at least one pair of a left-first supporting frame and a right-first supporting frame symmetrically arranged with the left-first supporting frame, wherein one of the second supporting frames is coupled between the left-first supporting frame and the right-first supporting frame.

Among the many possible implementations of the truck cargo rack, the horizontal supporting frames may comprise at least one first horizontal supporting frame coupled between a pair of second supporting frames.

Further, it is contemplated that the horizontal supporting frames comprise at least one second horizontal supporting frames, wherein one of the second horizontal supporting frames is coupled between a pair of the first supporting frames and the other one of the second horizontal supporting frame is coupled between another pair of the first supporting frames.

In the alternative, the base member may detachably adhere to the truck, and the main force distribution unit comprises an elongated screw end affixed on the second supporting frame and a securing unit inserted into the base member.

It is still further contemplated that the base member may comprise a receiving cavity and the main force distribution unit may comprise a securing unit inserted into the base member to form a buffering space between the base member and the securing unit.

In another aspect combinable with the general implementation, the base member comprises a receiving cavity and the main force distribution unit comprises an elongated screw end exposed outside the base member and a securing unit integrally extended from the elongated screw end.

In another aspect combinable with the general implementation, the main force distribution unit comprises a securing plate secured on the second supporting frame, an elongated screw end screwed on the securing plate, and a plurality of screw nuts detachably locked on the elongated screw end and the securing plate, wherein the plurality of screw nuts are configured to selectively secure the securing plate on a predetermined height position of the elongated screw end.

In another aspect combinable with the general implementation, the main force distribution unit comprises an elongated screw end having a threaded surface and a plurality of screw nuts matched with the threaded surface, wherein the screw nuts are moved along the elongated screw end.

In another aspect combinable with the general implementation, the main force distribution unit comprises a securing plate affixed on the second supporting frame, a plurality of screw nuts, and an elongated screw end passed through the securing plate and the screw nut, wherein the elongated screw end is indirectly affixing on the second supporting frame.

In another aspect combinable with the general implementation, the main force distribution unit comprises an elongated screw end affixed on the second supporting frame and a securing unit partially and detachably inserted into the base member.

In another aspect combinable with the general implementation, the force distribution assembly comprises an elongated screw end having an elongated screw end height which is shorter than a first supporting frame height of the first supporting frame.

In another aspect combinable with the general implementation, the at least one force distribution assembly comprises a pair of force distribution assemblies arranged adjacent to two free ends of the second supporting frame, wherein the pair of the force distribution assemblies are symmetrically arranged adjacent to two free ends of the second supporting frame to securely support the second supporting frame above the truck.

In another aspect combinable with the general implementation, the second supporting frame comprises two free ends, wherein the first locking unit is affixed on one of the two free ends, wherein the second locking unit is pivotally coupled to the first locking unit.

In another aspect combinable with the general implementation, the second locking unit is pivotally coupled to the first locking unit through a pivot mechanism, wherein the pivot mechanism comprises an elongated slot formed on the second locking unit and a pivot nut secured on the first locking unit, wherein the pivot nut is passed through the elongated slot and configured to move along the elongated slot.

In another aspect combinable with the general implementation, the first locking unit is partially and overlappedly arranged with the second locking unit, wherein the pivot mechanism comprises an elongated slot having a distal end and a proximal end and a pivot nut, wherein the pivot nut is biased against the distal end to perform a high affixing position and biased against the proximal end to perform a low affixing position,

In another aspect combinable with the general implementation, the second locking unit comprises a hook portion inwardly extended towards the first locking unit, wherein the hook portion is biased against the truck to secure the truck cargo rack on the truck.

In another aspect combinable with the general implementation, the first locking unit comprises a first main portion parallelly arranged and coupled with the second supporting frame and a first connection portion integrally extended from the first main portion and pivotally coupled with the second locking unit.

In another aspect combinable with the general implementation, the force distribution assembly comprises a base member and a main force distribution unit, wherein the base member and the main force distribution unit are vertically arranged with respect to the truck.

In another aspect combinable with the general implementation, the base member comprises a flat plane configured to bias against the truck and a receiving cavity formed on an opposite side of the flat plane.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, the operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be too precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of a truck cargo rack according to an aspect of the embodiments.

FIG. 2A is a perspective view of the truck cargo rack showing a locking assembly in a high affixing position according to an aspect of the embodiment.

FIG. 2B is a perspective view of the truck cargo rack showing the locking assembly in a low affixing position according to an aspect of the embodiment.

FIG. 3 is an exploded view of the locking assembly according to an aspect of the embodiment.

FIG. 4 is a sectional view of a force distribution assembly according to an aspect of the embodiment.

FIG. 5 is a sectional view of the force distribution assembly supported on a truck according to an aspect of the embodiment.

FIG. 6 is a bottom view of the force distribution assembly according to an aspect of the embodiment.

FIG. 7 is a side view of the truck cargo rack supported on the track according to an aspect of the embodiment.

FIG. 8A is a perspective view of the force distribution assembly and the locking assembly showing the locking assembly in the high affixing position according to an aspect of the embodiment.

FIG. 8B is a perspective view of the force distribution assembly and the locking assembly showing the locking assembly in the low affixing position according to an aspect of the embodiment

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

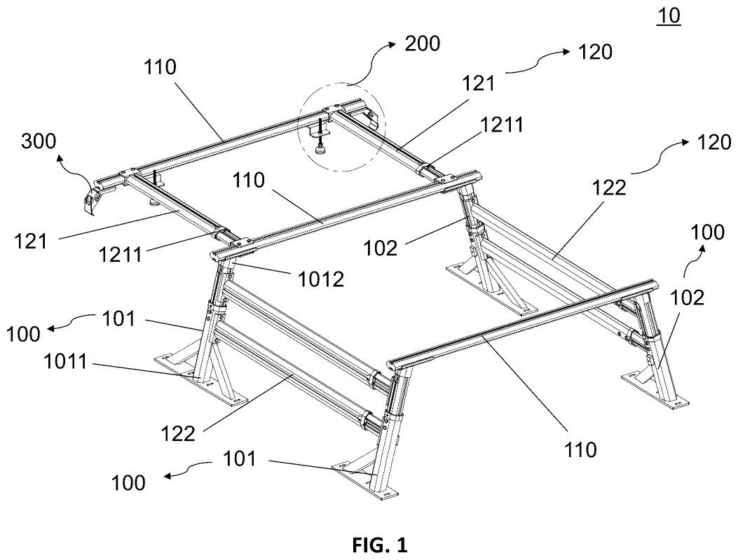

FIG. 1 generally depicts a truck cargo rack 10 according to an aspect of the embodiments.

Referring to FIG. 1, the truck cargo rack 10 may comprise a plurality of first supporting frames 100 uprightly supported on a truck and a plurality of second supporting frames 110 transversely coupled with the first supporting frame 100, wherein one of the second supporting frames 110 may be supported between a pair of the first supporting frame 100.

In some embodiments, each of the first supporting frames 100 may comprise a first supporting free end 1011 biased against the truck to support the truck cargo rack on the truck and a second supporting free end 1012 coupled on the second supporting frame 110, wherein the second supporting free end 1012 may be formed on an opposite side of the first supporting free end 1011.

In still some embodiments, the truck cargo rack 10 may comprise a plurality of horizontal supporting frames 120 coupled with the first supporting frames 100 and the second supporting frames 110, wherein the horizontal supporting frames 120 may comprise at least one first horizontal supporting frame 121 coupled between a pair of second supporting frames 110. It is important to know that the length of the first horizontal supporting frame 121 can be adjusted at a joint portion 1211.

In still some embodiments, the horizontal supporting frame 120 may comprise at least one second horizontal supporting frame 122, wherein one of the second horizontal supporting frames 122 may be coupled between a pair of the first supporting frames 100 and the other may be coupled between another pair of the first supporting frames 100.

Continuing to FIG. 1, in still some embodiments, the truck cargo rack 10 may further comprise at least one force distribution assembly 200 coupled with the second supporting frame 110 and configured to distribute a shaking force.

It should be noted that, in some embodiments, while the truck cargo rack 10 is installed on an operating truck, it may inevitably shake. In such a situation, the force distribution assembly 200 may be installed on the second supporting frame 110 to distribute a shaking force generated from the truck cargo rack 10.

Referring to further details in FIG. 1, the truck cargo rack 10 may further comprise at least one locking assembly 300 supported on the second supporting frame 110.

Continuing to FIG. 1, the first supporting frames 100 may comprise at least one pair of a left-first supporting frame 101 and a right-first supporting frame 102 symmetrically arranged with the left-first supporting frame 101, wherein one of the second supporting frames 110 may coupled between the left-first supporting frame 101 and the right-first supporting frame 102.

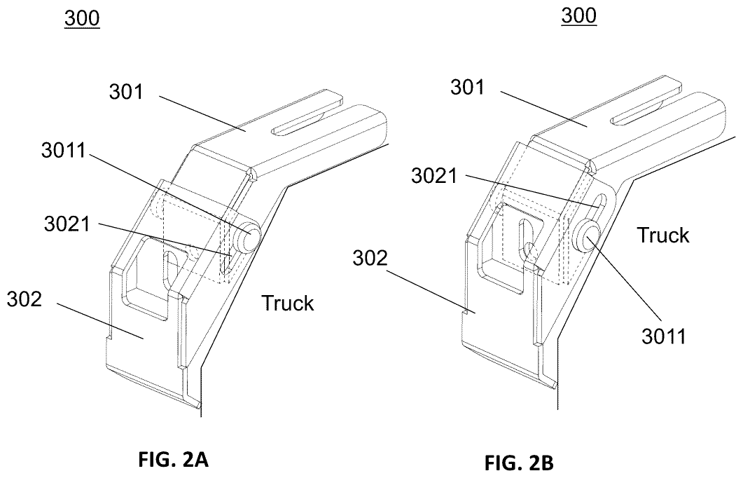

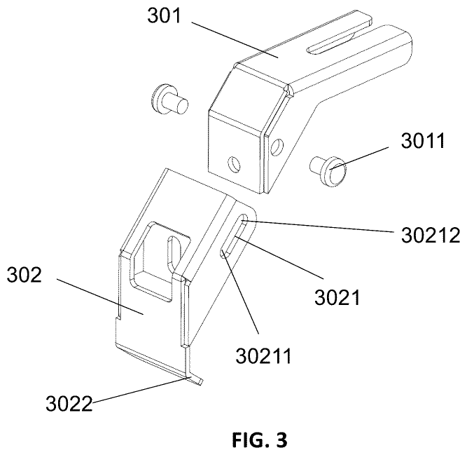

FIGS. 2A-3 generally depict the locking assembly 300 according to an aspect of the embodiments.

Referring to FIGS. 2A and 2B, in some embodiments, each of the locking assemblies 300 may comprise a first locking unit 301 and a second locking unit 302 pivotally coupled with the first locking unit 301 through a pivot mechanism to perform a high affixing position (as shown in FIG. 2A) and a low affixing position (as shown in FIG. 2B).

As shown in FIGS. 2A-3, in some embodiments, the second locking unit 302 may be pivotally coupled to the first locking unit 301 through the pivot mechanism, wherein the pivot mechanism comprises an elongated slot 3021 formed on the second locking unit 302 and a pivot nut 3011 secured on the first locking unit 301, wherein the pivot nut 3011 may be passed through the elongated slot 3021 and configured to move along the elongated slot 3021. In still some embodiments, the elongated slot 3021 may comprise a distal end 30212 and a proximal end 30211.

Referring back to FIGS. 2A-3, in some embodiments, the first locking unit 301 may be partially and overlappedly arranged with the second locking unit 302, wherein the pivot nut 3011 may be biased against the distal end 30212 (see FIG. 3) to perform the high affixing position, as shown in FIG. 2A and may be biased against the proximal end 30211 (see FIG. 3) to perform the low affixing position, as shown in FIG. 2B.

It should be noted that, in some embodiments, the second locking unit 302 may comprise a hook portion 3022 inwardly extended towards the first locking unit 301, wherein the hook portion 3022 may be biased against the truck to secure the truck cargo rack on the truck.

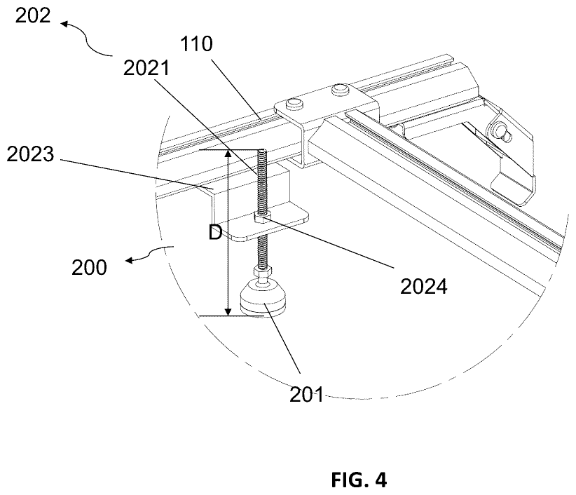

FIGS. 4-6 generally depict the force distribution assembly according to an aspect of the embodiments.

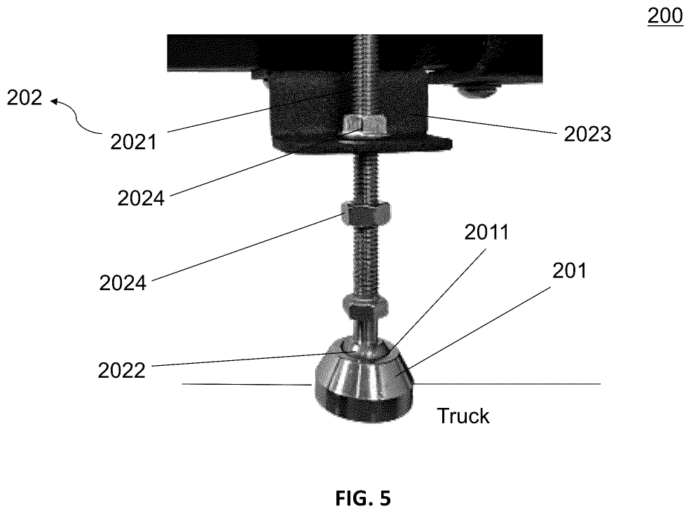

Referring to FIGS. 4-5, in some embodiments, the force distribution assembly 200 may comprise a base member 201 and a main force distribution unit 202 spacedly arranged with the base member 201 and locked on the base member 201.

In still some embodiments, as shown in FIG. 5, the base member may 201 be detachably adhered on the truck and the main force distribution unit 202 may further comprise an elongated screw end 2021 affixed on the second supporting frame 110 and a securing unit 2022 inserted into the base member 201.

In still some embodiments, the base member 201 may comprise a receiving cavity and the securing unit 2022 may be inserted into the receiving cavity of the base member 201 to form a buffering space 2011 located between the base member 201 and the securing unit 2022.

In still some embodiments, the elongated screw end 2021 may be exposed outside the base member 201 and the securing unit 2022 may be integrally extended from the elongated screw end 2021.

Referring back to FIG. 4, the main force distribution unit 202 may comprise a securing plate 2023 secured on the second supporting frame 110, wherein the elongated screw end 2021 may be screwed on the securing plate 2023. In some embodiments, the main force distribution unit 202 may comprise a plurality of screw nuts 2024 detachably locked on the elongated screw end 2021 and the securing plate 2023 and configured to selectively secure the securing plate 2023 on a predetermined height position of the elongated screw end 2021.

Continuing to FIG. 5, in some embodiments, the main force distribution unit 202 may comprise the elongated screw end 2021 having a threaded surface and the plurality of screw nuts 2024 may match with the threaded surface, wherein the screw nuts 2024 may move along the elongated screw end 2021 to secure the elongated screw end 2021 with the securing plate 2023.

In still some embodiments, it should be noted that the securing unit 2022 may be partially and detachably inserted into the base member 201.

It should be noted that, in some embodiments, the base member 201 and the main force distribution unit 202 are vertically arranged with respect to the truck.

In still some embodiments, the elongated screw end 2021 may be passed through the securing plate 2023 and the plurality of screw nuts 2024 to be securely affixed on the securing plate 2023 through the screw nuts 2024, and in such a way, the elongated screw end 2021 may be indirectly affixing on the second supporting frame 110.

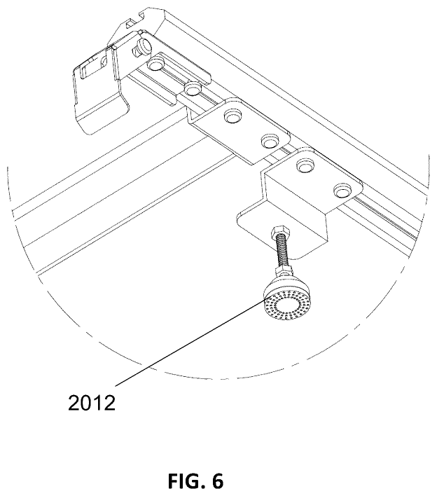

Continuing to FIGS. 5-6, the base member 201 comprises a flat plane 2012 configured to bias against the truck and the receiving cavity formed on an opposite side of the flat plane 2012, wherein the flat plane 2012 may be adhered to the truck and selectively detach from the truck.

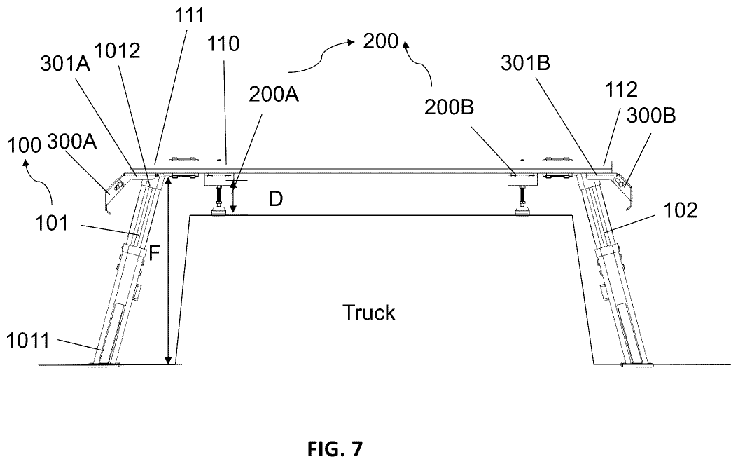

FIG. 7 generally depicts a rear view of the truck cargo rack according to an aspect of the embodiments.

Referring to FIG. 7. the force distribution assembly 200 may comprise a distribution unit height “D” defined by a total height from the elongated screw end 2021 and the base member 201 (as shown in FIG. 4), and the first supporting frame 100 may comprise a first supporting frame height “F” defined from the first supporting free end 1011 of the first supporting frame 100 to the second supporting free end 1012 of the first supporting frame 100, and at this situation, the distribution unit height “D” may be shorter than the first supporting frame height “F.”

As shown in further details in FIG. 7, in some embodiments, the at least one force distribution assembly 200 may comprise a pair of force distribution assemblies 200A, 200B arranged adjacent to two free ends of the second supporting frame 110, wherein the pair of the force distribution assemblies 200A, 200B may be symmetrically arranged adjacent to two free ends of the second supporting frame 110 to securely support the second supporting frame 110 above the truck.

In still some embodiments, the second supporting frame 110 may comprise two free ends 111, 112, wherein one of the two free ends 111 may be formed on an opposite side of the other one of the two free ends 112.

In still another embodiment, the truck cargo rack may comprise a pair of locking assemblies 300A, 300B, wherein one of the locking assemblies 300A may be affixed to one of the two free ends 111, and the other of the locking assemblies 300B may be affixed to the other one of the two free ends 112.

Referring to further details in FIG. 7, the first locking unit 301A of one of the pair of the locking assemblies 300A may be affixed to one of the two free ends 111 of the second supporting frame 110, and the first locking unit 301B of the other pair of the locking assemblies 301B may be affixed to the other one of the two free ends 112 of the second supporting frame 110.

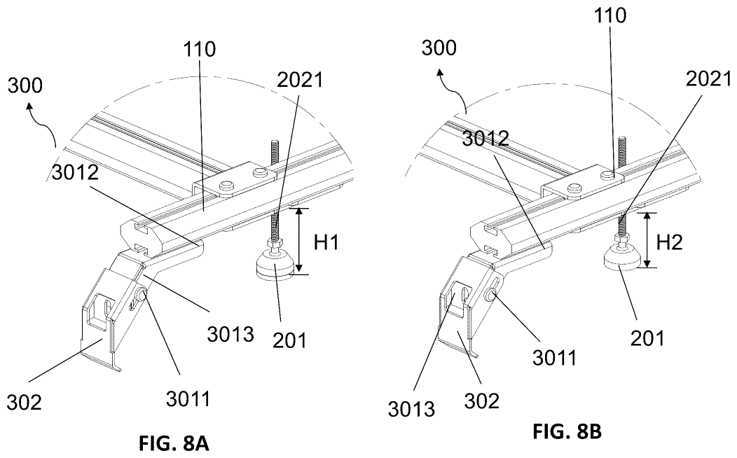

FIGS. 8A-8B generally depicts a locking assembly 300 in the high affixing position and the low affixing position according to an aspect of the embodiments.

Referring to FIGS. 8A-8B, the first locking unit 301 may comprise a first main portion 3012 parallelly arranged and coupled with the second supporting frame 110 and a first connection portion 3013 pivotally coupled with the second locking unit 302. In some embodiments, while the locking assembly 300 is in the high affixing position, the pivot nut 3011 may be biased against the distal end 30212 of the elongated slot 3021 (FIG. 3), and in such a manner, the elongated screw end 2021 may comprise a first supporting height “H1” defined between the second supporting frame 110 and the base member 201.

Continuing to FIGS. 8A-8B, in still some embodiments, while the locking assembly 300 is on the low affixing position, the pivot nut 3011 may be biased against the proximal end 30211 of the elongated slot 3021 (see FIG. 3), and in such a manner, the elongated screw end 2021 may comprise a second supporting height “H2” defined between the second supporting frame 110 and the base member 201. It should be noted that, in some embodiments, the first supporting height “H1” may be longer than the second supporting height “H2” to support the second supporting frame 110 in the high affixing position and the low affixing position.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.

Thus, specific embodiments and applications of truck cargo rack have been disclosed. It should be apparent, however, to those skilled in the art that many more modifications besides those already described are possible without departing from the disclosed concepts herein. The disclosed embodiments, therefore, are not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted, and what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A truck cargo rack, comprising:
a plurality of first supporting frames uprightly supported on a truck;
a plurality of second supporting frames transversely coupled with the first supporting frame;
a plurality of horizontal supporting frames coupled with the first supporting frames and the second supporting frames;
at least one force distribution assembly coupled with the second supporting frame and configured to distribute a shaking force; and
at least one locking assembly having a first locking unit and a second locking unit pivotally coupled with the first locking unit through a pivot mechanism to perform a high affixing position and a low affixing position; wherein
the force distribution assembly comprises a base member and a main force distribution unit spacedly arranged with the base member and locked on the base member.

2. The truck cargo rack of claim 1, wherein the first supporting frames comprise at least one pair of a left-first supporting frame and a right-first supporting frame symmetrically arranged with the left-first supporting frame, wherein one of the second supporting frames is coupled between the left-first supporting frame and the right-first supporting frame.

3. The truck cargo rack of claim 1, wherein the horizontal supporting frames comprise at least one first horizontal supporting frame coupled between a pair of second supporting frames.

4. The truck cargo rack of claim 1, wherein the horizontal supporting frames comprise at least one second horizontal supporting frames, wherein one of the second horizontal supporting frames is coupled between a pair of the first supporting frames and the other one of the second horizontal supporting frames is coupled between another pair of the first supporting frames.

5. The truck cargo rack of claim 1, wherein the base member is detachably adhered to the truck and the main force distribution unit comprises an elongated screw end affixed on the second supporting frame and a securing unit inserted into the base member.

6. The truck cargo rack of claim 1, wherein the main force distribution unit comprises a securing unit inserted into the base member to form a buffering space between the base member and the securing unit.

7. The truck cargo rack of claim 1, wherein the main force distribution unit comprises an elongated screw end exposed outside the base member and a securing unit integrally extended from the elongated screw end.

8. The truck cargo rack of claim 1, wherein the main force distribution unit comprises a securing plate secured on the second supporting frame, an elongated screw end screwed on the securing plate, and a plurality of screw nuts detachably locked on the elongated screw end and the securing plate, wherein the plurality of screw nuts are configured to selectively secure the securing plate on a predetermined height position of the elongated screw end.

9. The truck cargo rack of claim 1, wherein the main force distribution unit comprises an elongated screw end having a threaded surface and a plurality of screw nuts matched with the threaded surface, wherein the screw nuts are moved along the elongated screw end.

10. The truck cargo rack of claim 1, wherein the main force distribution unit comprises a securing plate affixed on the second supporting frame, a plurality of screw nuts, and an elongated screw end passed through the securing plate and the screw nut, wherein the elongated screw end is indirectly affixing on the second supporting frame.

11. The truck cargo rack of claim 1, wherein the main force distribution unit comprises an elongated screw end affixed on the second supporting frame and a securing unit partially and detachably inserted into the base member.

12. The truck cargo rack of claim 1, wherein the force distribution assembly comprises an elongated screw end having an elongated screw end height which is shorter than a first supporting frame height of the first supporting frame.

13. The truck cargo rack of claim 1, wherein the at least one force distribution assembly comprises a pair of force distribution assemblies arranged adjacent to two free ends of the second supporting frame, wherein the pair of the force distribution assemblies are symmetrically arranged adjacent to two free ends of the second supporting frame to securely support the second supporting frame above the truck.

14. The truck cargo rack of claim 1, wherein the second supporting frame comprises two free ends, wherein one of the two free ends is formed on an opposite side of the other one of the two free ends, wherein the first locking units of the locking assemblies are affixed on the two free ends.

15. The truck cargo rack of claim 1, wherein the pivot mechanism comprises an elongated slot formed on the second locking unit and a pivot nut secured on the first locking unit, wherein the pivot nut is passed through the elongated slot and configured to move along the elongated slot.

16. The truck cargo rack of claim 1, wherein the first locking unit is partially and overlappedly arranged with the second locking unit, wherein the pivot mechanism comprises a pivot nut and an elongated slot having a distal end and a proximal end, wherein the pivot nut is biased against the distal end to perform a high affixing position and biased against the proximal end to perform a low affixing position.

17. The truck cargo rack of claim 1, wherein the second locking unit comprises a hook portion inwardly extended towards the first locking unit, wherein the hook portion is biased against the truck to secure the truck cargo rack on the truck.

18. The truck cargo rack of claim 1, wherein the first locking unit comprises a first main portion parallelly arranged and coupled with the second supporting frame and a first connection portion integrally extended from the first main portion and pivotally coupled with the second locking unit.

19. The truck cargo rack of claim 1, wherein the force distribution assembly comprises a base member and a main force distribution unit, wherein the base member and the main force distribution unit are vertically arranged with respect to the truck.

20. The truck cargo rack of claim 1, wherein the base member comprises a flat plane configured to bias against the truck and a buffering space formed on an opposite side of the flat plane.
